(19) United States
(12) Patent Application Publication
(10) Pub. No.: US 2004/0022017 A1
(43) Pub. Date: Feb. 5, 2004

(54) Universal coupling cassette for computer facilities

(76) Inventor: Michael Chuang, Chong Ho City (TW)

Correspondence Address: Michael Chuang, P.O.Box 10-69, Chong Ho, Taipei, TW

(21) Appl. No.: 10/212,647

(22) Filed: Aug. 2, 2002

(51) Int. Cl. G06F 1/16

(52) U.S. Cl. 361/683; 361/685

(57) ABSTRACT

A universal coupling cassette for coupling to a computer facility includes a housing having a front opening, and a bulge, a receptacle disposed in the housing and having two or more couplers for coupling to the computer facility. A casing includes two or more rear coupler for selectively coupling to the couplers of the receptacle when the casing is engaged into the opening of the housing, and includes two or more front channels for receiving various kinds of cards or interfaces, without coupling additional wires or card readers.

### BACKGROUND OF THE INVENTION

1. Field of the Invention

The present invention relates to a coupling cassette, and more particularly to a universal coupling cassette for computer facilities.

2. Description of the Prior Art

Typically, one or more card readers are required to be coupled to the computer facilities respectively or separately, for allowing various kinds of cards or interfaces to be coupled to the computer facilities separately. For example, for the Institute of Electrical and Electronics Engineers (IEEE) 1394 cards or interfaces, a predetermined or a selected card reader is required to be coupled to the computer facilities for allowing the IEEE1394 cards or interfaces to be coupled to the computer facilities.

However, for such as the universal serial bus (USB) cards or interfaces, another card reader is required to be coupled to the computer facilities for allowing the USB cards or interfaces to be coupled to the computer facilities. In addition, an additional electric power source is further required to be provided and coupled to the USB cards or interfaces, for energizing the USB cards or interfaces. The users thus may not easily use the IEEE1394 and/or USB and/or the other cards or interfaces.

The present invention has arisen to mitigate and/or obviate the afore-described disadvantages of the conventional card readers.

### SUMMARY OF THE INVENTION

The primary objective of the present invention is to provide a universal coupling cassette for allowing various cards or interfaces to be easily coupled or plugged to the computer facilities without coupling additional wires or card readers.

In accordance with one aspect of the invention, there is provided a universal coupling cassette for coupling to a computer facility, the universal coupling cassette comprising a housing including a front plate having an opening formed therein, and including a bulge extended therein, a receptacle disposed in the housing, and including a first coupler and at least one second coupler provided therein, a third and a fourth coupler coupled to the first coupler and the at least one second coupler respectively for coupling to the computer facility, and a casing including a rear portion having a fifth and at least one sixth coupler provided therein for selectively coupling to the first coupler and the at least one second coupler respectively when the casing is engaged into the opening of the housing, the casing including a front portion having at least two channels formed therein for receiving cards or interfaces.

A device is further provided for guiding the fifth and at least one sixth coupler to be engaged and coupled to the first coupler and the second coupler respectively.

The guiding means includes a bulge extended in the housing, and a cavity formed in the casing for receiving the bulge and for guiding the fifth and at least one sixth coupler to be coupled to the first coupler and the second coupler respectively.

The bulge includes a rounded leading end for facilitating an engagement of the bulge into the cavity of the casing.

Alternatively, the guiding means includes a pair of guide walls provided in the housing for guiding and receiving the casing therebetween. The guide walls each includes an outwardly curved front portion for facilitating the casing to engage into the opening of the housing.

A device may further be provided for latching the casing to the housing, and includes a pair of spring blades provided on the casing, and each having a catch extended therefrom for engaging with the front plate and for locking the casing to the housing.

The housing includes a peripheral flange for defining the opening thereof, and at least one depression formed in the front plate and communicating with the opening thereof, for facilitating an engagement of the catch into the opening of the front plate.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a computer facility having a universal coupling cassette in accordance with the present invention;

FIG. 2 is a perspective view of the universal coupling cassette;

FIG. 3 is an exploded view of the universal coupling cassette;

FIG. 4 is a bottom perspective view of the universal coupling cassette;

FIG. 5 is an upper schematic view illustrating the inner structure of the universal coupling cassette;

FIG. 6 is a perspective view illustrating the disengaging of a casing from a housing of the universal coupling cassette;

FIG. 7 is an exploded view illustrating the disengaging or the engaging of the casing from or into the housing of the universal coupling cassette; and

FIG. 8 is a perspective view illustrating the coupling or the superposing of two casings of the universal coupling cassette.

### DETAILED DESCRIPTION OF THE PREFERRED EMBODIMENT

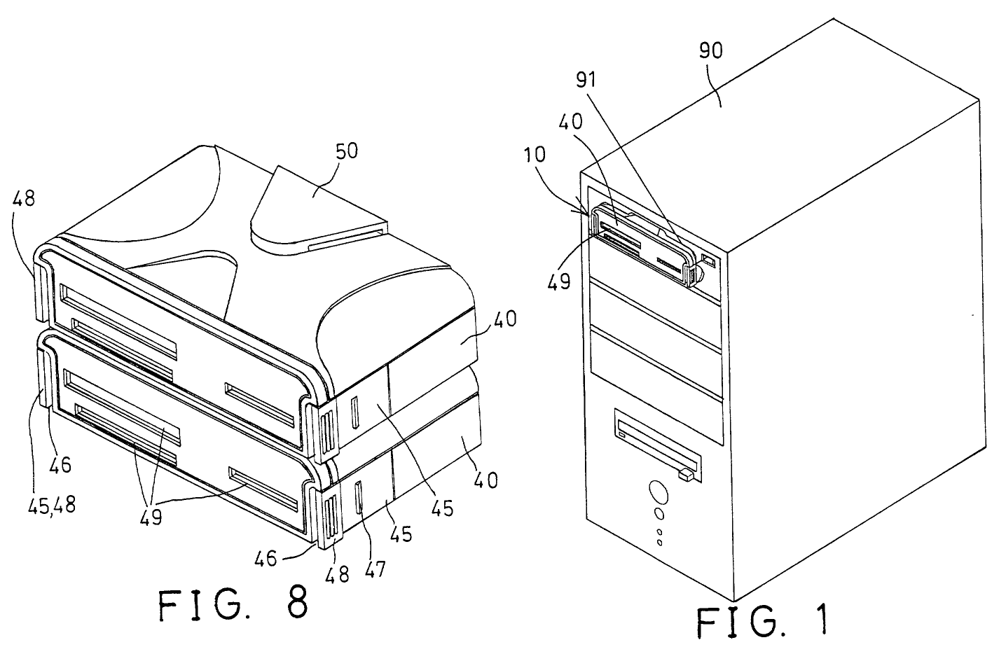

Referring to the drawings, and initially to FIG. 1, a universal coupling cassette in accordance with the present invention is generally indicated with a reference numeral “10” and is going to be engaged into either one of the typical slots 91 of the typical computer facility 90.

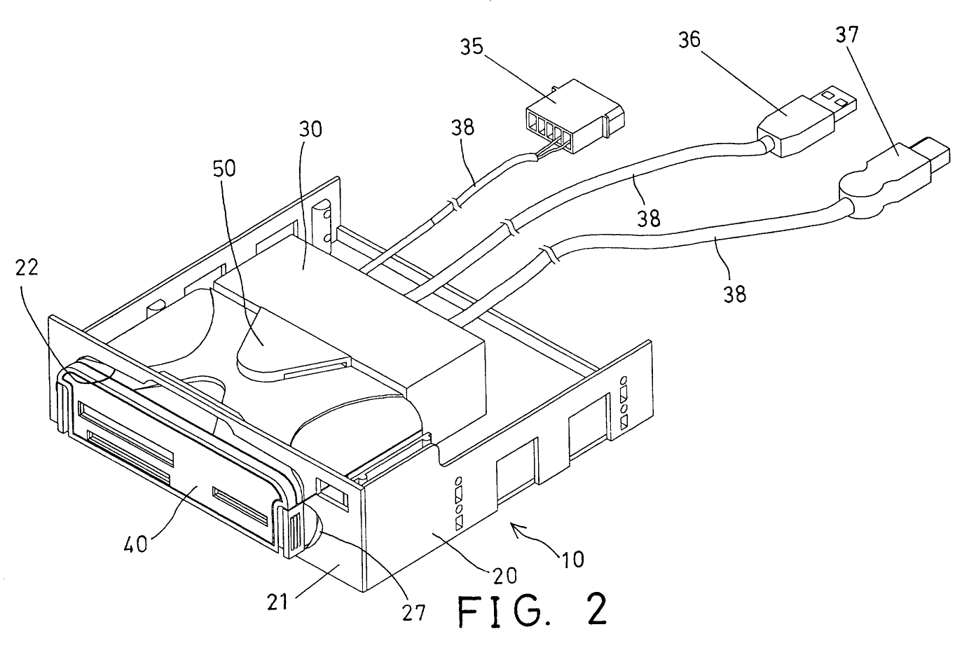

Referring next to FIGS. 2-5, the universal coupling cassette 10 comprises a housing 20 including a front plate 21 having an opening 22 formed therein and formed or defined by a peripheral flange 23, for receiving a casing 40 therein.

The front plate 21 includes one or more depressions 27 formed in the front portion thereof, such as formed in the front portion of the peripheral flange 23 and communicating with the opening 22 thereof, for facilitating or for guiding the casing 40 to engage into the opening 22 of the housing 20.

The housing 20 includes one or more, such as a pair of guide walls 24 disposed therein and parallel to each other, and preferably aligned with the sides of the peripheral flange 23 or of the opening 22 of the housing 20, and each having an outwardly curved front portion 28 for further facilitating the casing 40 to engage into the opening 22 of the housing 20, and for allowing the casing 40 to be stably or snugly retained in the housing 20 by the guide walls 24.

The housing 20 further includes a bulge 25 extended or provided therein, and having a substantially triangular structure or shape and having a curved or rounded leading end 26.

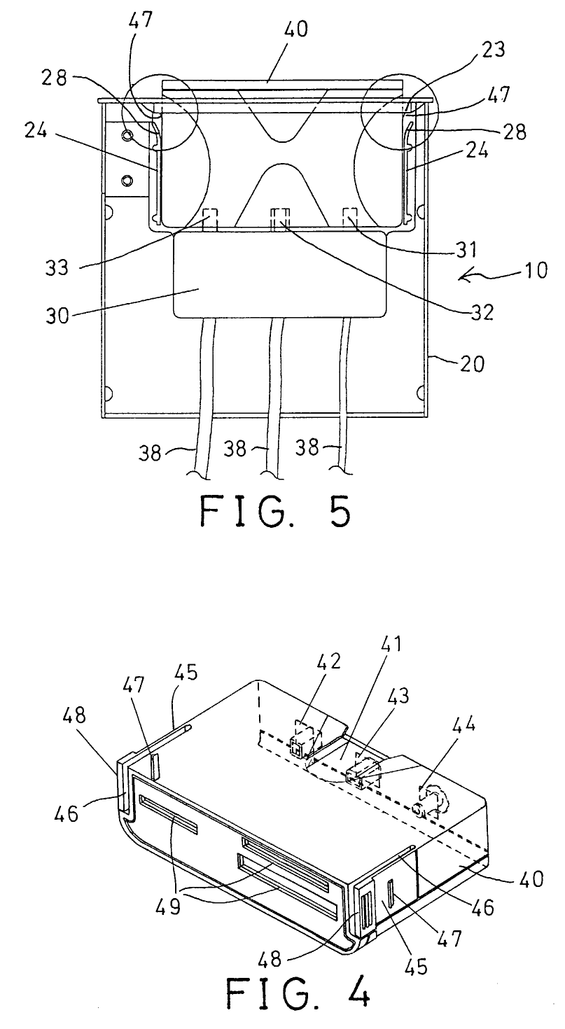

As best shown in FIG. 4, the casing 40 includes a cavity 41 formed in the bottom portion thereof and having a substantially triangular structure or shape similar to that of the bulge 25 of the housing 20, for receiving the bulge 25, and for further stably or snugly coupling the casing 40 to the housing 20.

The housing 20 includes a receptacle 30 disposed or provided therein, and having two or more plugs or sockets or couplers 31, 32, 33 attached or provided thereto, and coupled to another plug or socket or coupler 35, 36, 37 with wires 38 respectively.

The couplers 35, 36, 37 may be coupled to the computer facility 90. The coupler 31 is a power coupler for coupling to the electric power source of the computer facility 90. The other coupler 32 may be a USB coupler, and the further coupler 33 may be an IEEE1394 coupler, for example.

As shown in FIG. 4, the casing 40 includes two or more plugs or sockets or couplers 42, 43, 44 attached or provided therein, such as provided in the rear portion thereof, for coupling to the couplers 31, 32, 33 of the receptacle 30 or of the housing 20 respectively.

The couplers 31, 32, 33 of the receptacle 30 may be precisely guided to engage into or to be coupled to the couplers 42, 43, 44 of the casing 40 respectively, by the engagement of the bulge 25 of the housing 20 into the cavity 41 of the casing 40.

Or, when the casing 40 is engaged into the opening 22 of the housing 20, the bulge 25 of the housing 20 may be guided to be engaged into the cavity 41 of the casing 40, such that the couplers 31, 32, 33 of the receptacle 30 may be precisely guided to engage into or to be coupled to the couplers 42, 43, 44 of the casing 40 respectively.

The engagement of the bulge 25 of the housing 20 into the cavity 41 of the casing 40 and/or the guide walls 24 may thus form a guiding means or device for guiding the couplers 31, 32, 33 of the receptacle 30 to be precisely guided to engage into or to be coupled to the couplers 42, 43, 44 of the casing 40 respectively.

The casing 40 includes one or more channels 49 formed in the front portion thereof for receiving various kinds of cards or interfaces, such as the USB or IEEE1394 cards or interfaces, for allowing the cards or interfaces to be coupled to the computer facilities 90. The USB or IEEE1394 cards or interfaces are typical and have not shown in the drawings.

The coupler 31, 35 may be coupled to the electric power source of the computer facility 90, for example, in order to energize the universal coupling cassette, for allowing the cards or interfaces to be used without additional electric power sources, and without coupling to the other electric power sources.

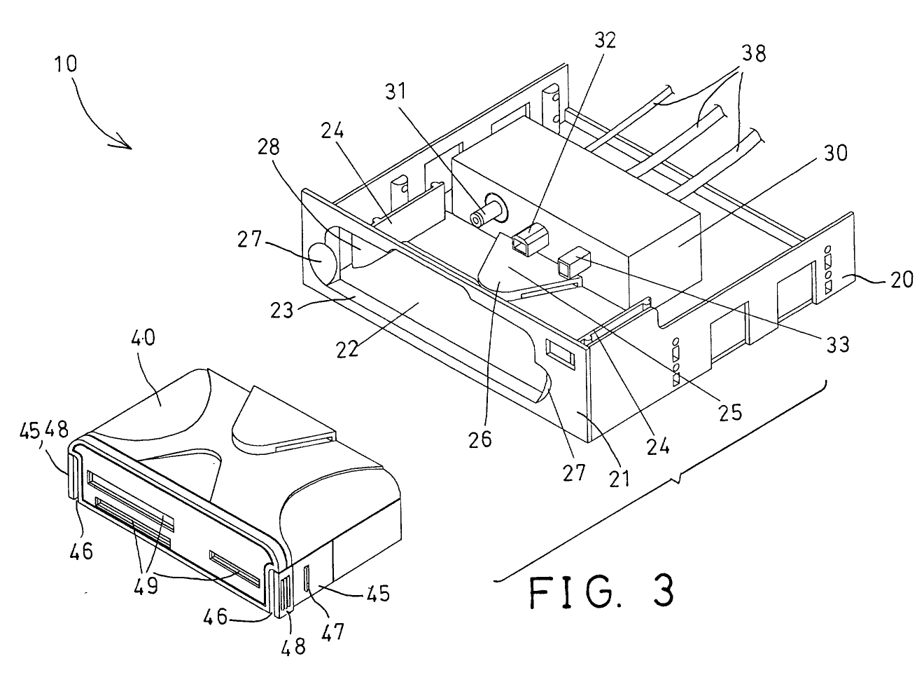

As shown in FIGS. 3-7, the casing 40 includes one or more, such as a pair of resilient or spring blades 45 extended or provided in the front and side portions thereof, and a gap 46 formed between the casing 40 and the spring blades 45 respectively for increasing or providing the resilience to the spring blades 45.

The spring blades 45 each includes a catch 47 extended laterally outward therefrom, for engaging into the opening 22 of the housing 20, and for engaging with the peripheral flange 23 of the housing 20, and for detachably locking or latching the casing 40 to the housing 20, best shown in FIG. 5.

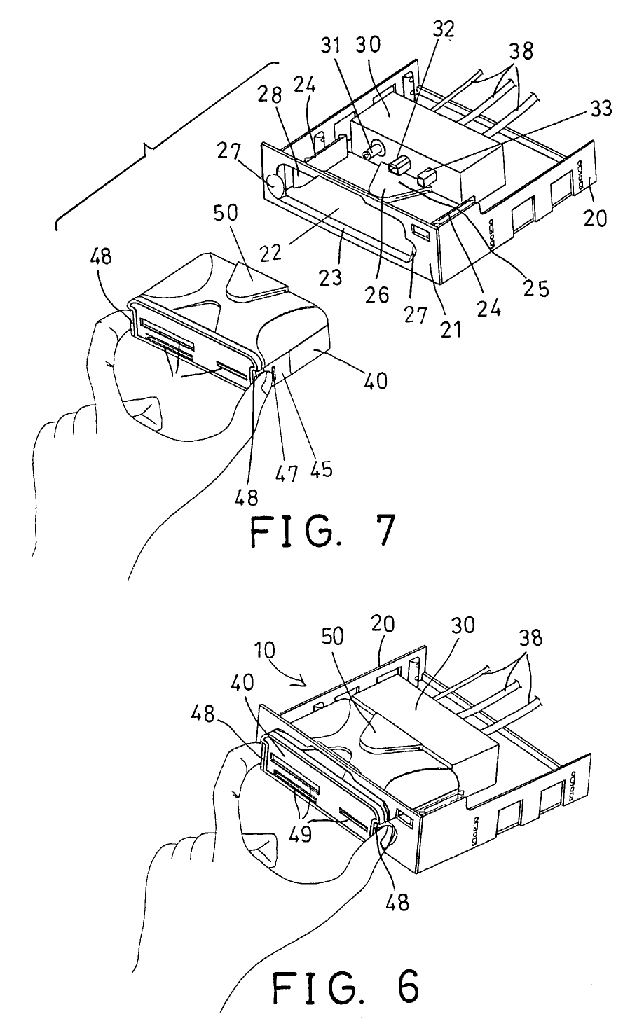

The spring blades 45 each preferably includes a knob 48 provided on the front portion thereof, for allowing the spring blades 45 to be depressed toward each other or toward the casing 40, and for selectively disengaging the catches 47 from the peripheral flange 23 of the housing 20, and thus for allowing the casing 40 to be removed or disengaged from the opening 22 of the housing 20 (FIGS. 6, 7).

When the casing 40 is engaged into the opening 22 of the housing 20, the catches 47 may be engaged with the depressions 27 of the front plate 21, such that the spring blades 45 may be forced or depressed toward each other or toward the casing 40, for allowing the catches 47 to be engaged into the housing 20 and to be engaged with the peripheral flange 23 of the housing 20, in order to lock or to latch the casing 40 to the housing 20.

The spring blades 45 and/or the catches 47 may thus form a means or a device for latching the casing 40 to the housing 20.

The casing 40 each preferably includes a swelling 50 extended therefrom, for engaging into the cavity 41 of the casing 40 (FIG. 4), and for allowing two or more casings 40 to be stacked or superposed with each other, as shown in FIG. 8. The coupling or superposing structure is good for storing or for transportation purposes.

In operation, when the universal coupling cassette assembly 10 is coupled to the computer facility 90, as shown in FIG. 1, various kinds of cards or interfaces may be easily and quickly engaged or plugged into the channels 49 of the casing 40, without coupling the other wires or card readers or the other peripheral facilities to the computer facilities.

Accordingly, the universal coupling cassette in accordance with the present invention may be provided for allowing various cards or interfaces to be easily coupled or plugged to the computer facilities without coupling additional wires or card readers.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A universal coupling cassette for coupling to a computer facility, said universal coupling cassette comprising:
a housing including a front plate having an opening formed therein, and including a bulge extended therein,
a receptacle disposed in said housing, and including a first coupler and at least one second coupler provided therein, a third and a fourth coupler coupled to said first coupler and said at least one second coupler respectively for coupling to the computer facility, and
a casing including a rear portion having a fifth and at least one sixth coupler provided therein for selectively coupling to said first coupler and said at least one second coupler respectively when said casing is engaged into said opening of said housing, said casing including a front portion having at least two channels formed therein for receiving cards or interfaces.

2. The universal coupling cassette according to claim 1 further comprising means for guiding said fifth and at least one sixth coupler to be engaged and coupled to said first coupler and said at least one second coupler respectively.

3. The universal coupling cassette according to claim 2, wherein said guiding means includes a bulge extended in said housing, and a cavity formed in said casing for receiving said bulge and for guiding said fifth and at least one sixth coupler to be coupled to said first coupler and said at least one second coupler respectively.

4. The universal coupling cassette according to claim 3, wherein said bulge includes a rounded leading end for facilitating an engagement of said bulge into said cavity of said casing.

5. The universal coupling cassette according to claim 2, wherein said guiding means includes a pair of guide walls provided in said housing for guiding and receiving said casing therebetween.

6. The universal coupling cassette according to claim 5, wherein said guide walls each includes an outwardly curved front portion for facilitating said casing to engage into said opening of said housing.

7. The universal coupling cassette according to claim 1 further comprising means for latching said casing to said housing.

8. The universal coupling cassette according to claim 7, wherein said latching means includes a pair of spring blades provided on said casing, and each having a catch extended therefrom for engaging with said front plate and for locking said casing to said housing.

9. The universal coupling cassette according to claim 8, wherein said housing includes a peripheral flange for defining said opening thereof, and at least one depression formed in said front plate and communicating with said opening thereof, for facilitating an engagement of said catch into said opening of said front plate.
